(19) United States
(12) Patent Application Publication
(10) Pub. No.: US 2013/0222427 A1
(43) Pub. Date: Aug. 29, 2013

(54) SYSTEM AND METHOD FOR IMPLEMENTING INTERACTIVE AUGMENTED REALITY

(71) Applicant: ELECTRONICS AND TELECOMMUNICATIONS R, (US)

(72) Inventors: Gi Su HEO, Jeonju (KR); Hyun Tae JEONG, Daejeon (KR); Dong Woo LEE, Daejeon (KR); Jun Seok PARK, Daejeon (KR)

(73) Assignee: ELECTRONICS AND TELECOMMUNICATIONS RESEARCH INSTITUTE, Daejeon (KR)

(21) Appl. No.: 13/647,362

(22) Filed: Oct. 8, 2012

(30) Foreign Application Priority Data
Feb. 29, 2012 (KR) 10-2012-0020726

(51) Int. Cl. G09G 5/377

(52) U.S. Cl. 345/633

(57) ABSTRACT

An augmented reality implementing system is disclosed. The augmented reality implementing system includes an image outputting device and an augmented reality implementing device. The augmented reality implementing device derives an object from a captured image of a specific space and extracts a predetermined virtual object corresponding to the derived object; when an image of a user tool for interaction with the virtual object is included in the captured image, reflects a motion command corresponding to a motion pattern of the user tool on the virtual object; and generates a new image by reflecting the virtual object on the captured image, and outputs the new image to the image outputting device.

### CLAIM FOR PRIORITY

This application claims priority to Korean Patent Application No. 10-2012-0020726 filed on Feb. 29, 2012 in the Korean Intellectual Property Office (KIPO), the entire contents of which are hereby incorporated by reference.

### BACKGROUND

1. Technical Field

Example embodiments of the present invention relate in general to a system and method for implementing augmented reality, and more specifically, to a system and method for implementing augmented reality, which provide interactions with users by adding virtual objects to real objects.

2. Related Art

Virtual reality covers only virtual spaces and objects, whereas augmented reality combines the real world with virtual objects to provide additional augmented information that is difficult to obtain by the real world alone. In other words, unlike virtual reality based on a virtual world, augmented reality augments reality by combining real environments with virtual objects.

Therefore, augmented reality is applicable to a variety of real environments, unlike virtual reality that is limitedly applicable only to a field such as games. In particular, augmented reality is in the spotlight as next-generation display technology suitable for ubiquitous environments. In ubiquitous computing environments, usual objects and places perform information processing and information exchange through augmented reality. Herein, objects or targets thereof may not only be those that are fixed at specific positions or places, but also be those that move continuously. However, real-time interaction in a three-dimensional space should be performed smoothly so that a real image and a virtual image can be effectively combined. Thus, augmented reality should provide users with a higher reality than virtual reality.

For example, board games are played on flat game boards by using simple physical tools (cards), and board games also available in portable terminals are emerging. As an example, Nintendo DS Magical Thousand-Character Text 2 (Final magic Chinese character) and a smart phone application “Magical Thousand-Character Text” provide environments enabling users to play and learn through personal terminals. However, users are inconvenienced because the game is played through a small display screen, and there is a problem in that several terminals are required so that several users may compete at the same time. In addition, there is a problem in that real-time interaction between the user and virtual world cannot be effectively provided.

### SUMMARY

Accordingly, example embodiments of the present invention are provided to substantially obviate one or more problems due to limitations and disadvantages of the related art.

Example embodiments of the present invention provide an augmented reality implementing system for effectively providing real-time interactions with users.

Example embodiments of the present invention also provide an augmented reality implementing method for effectively providing real-time interactions with users.

In some example embodiments, a system for implementing augmented reality includes: an image outputting device; and an augmented reality implementing device configured to: derive an object from a captured image of a specific space and extract a predetermined virtual object corresponding to the derived object; when an image of a user tool for interaction with the virtual object is included in the captured image, reflect a motion command corresponding to a motion pattern of the user tool on the virtual object; and generate a new image by reflecting the virtual object on the captured image, and output the new image to the image outputting device.

The augmented reality implementing device may include: an image capturing unit configured to capture a photographed image of a specific space; a virtual object extracting unit configured to derive an object from the captured image and extract a virtual object corresponding to the derived object from a virtual object storage; a motion command extracting unit configured to, when an image of a user tool for interaction with the virtual object is included in the captured image, derive a motion pattern of the user tool and extract a motion command corresponding to the derived motion pattern from a motion pattern storage; an image processing unit configured to add an image of the extracted virtual object to the captured image and reflect the extracted motion command on the virtual object to generate a new image; and an image outputting unit configured to output the image generated by the image processing unit to the image outputting device.

The image outputting device may insert an infrared specific pattern into a received image prior to projection onto a specific space, and the system may further include an infrared camera configured to photograph an infrared specific pattern projected onto the specific space. The image capturing unit may capture the infrared specific pattern photographed by the infrared camera, and the motion command extracting unit may derive a motion pattern of the user tool based on the captured infrared specific pattern.

When the user tool is a hand, the motion command extracting unit may extract a hand region based on the infrared specific pattern and analyze a fingertip region to extract the motion pattern.

The system may further include a visible-ray camera configured to photograph an image of a user tool or an image of the object from the specific space, and the image capturing unit may combine images captured from the visible-ray camera and the infrared camera.

In other example embodiments, a method for implementing augmented reality in an augmented reality implementing device includes: an image capturing step of capturing a photographed image of a specific space; a virtual object extracting step of deriving an object from the captured image and extracting a virtual object corresponding to the derived object from a virtual object storage; a motion command extracting step of, when an image of a user tool for interaction with the virtual object is included in the captured image, deriving a m motion pattern of the user tool and extracting a motion command corresponding to the derived motion pattern from a motion pattern storage; an image processing step of adding an image of the extracted virtual object to the captured image and reflecting the extracted motion command on the virtual object to generate a new image; and an image outputting step of outputting the generated image to an image outputting device.

The image outputting device may project an infrared specific pattern onto the specific space, the image capturing step may capture the infrared specific pattern photographed by an infrared camera, and the motion command extracting step may derive a motion pattern of the user tool based on the captured infrared specific pattern.

When the user tool is a hand, the motion command extracting step may extract a hand region based on the infrared specific pattern and analyze a fingertip region to derive the motion pattern.

When the object is a marker-based object, the virtual object extracting step may detect a marker from an image of the derived object and extract a virtual object corresponding to the detected marker from the virtual object storage.

### BRIEF DESCRIPTION OF DRAWINGS

Example embodiments of the present invention will become more apparent by describing in detail example embodiments of the present invention with reference to the accompanying drawings, in which:

FIG. 1 is a block diagram illustrating elements of an augmented reality implementing system and relations between the elements according to an example embodiment of the present invention;

FIG. 2 is a flow diagram illustrating an augmented reality implementing process according to an example embodiment of the present invention;

FIG. 3 is a conceptual diagram illustrating an example of providing a service by using m an augmented reality implementing system according to an example embodiment of the present invention;

FIG. 4 is a conceptual diagram illustrating a change corresponding to a hand motion of an infrared specific pattern projected by a projector of an augmented reality implementing system according to an example embodiment of the present invention; and

FIG. 5 is a conceptual diagram illustrating an image corresponding to the extraction of only an infrared specific pattern from an image projected by a projector of an augmented reality implementing system according to an example embodiment of the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternate forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

It should also be noted that in some alternative implementations, operations may be performed out of the sequences depicted in the flowcharts. For example, two operations shown in the drawings to be performed in succession may in fact be executed substantially concurrently or even in reverse of the order shown, depending upon the functionality/acts involved.

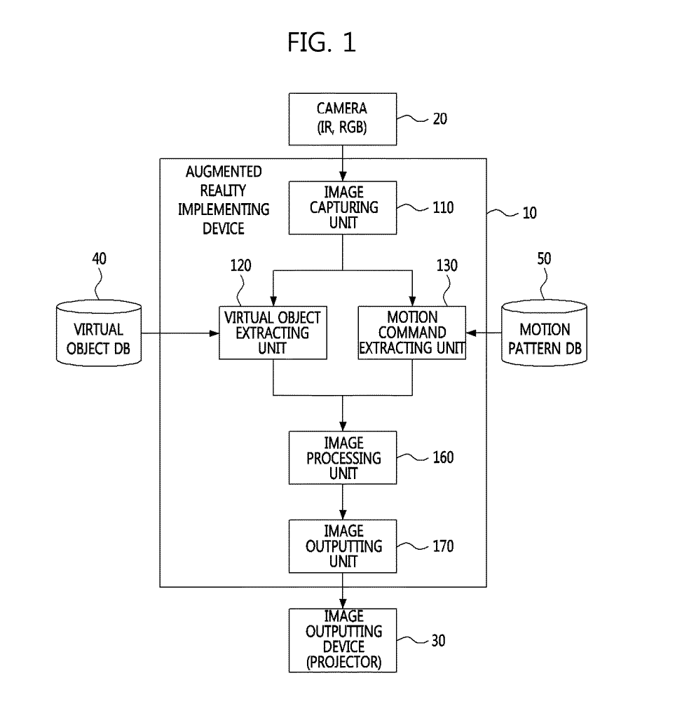

FIG. 1 is a block diagram illustrating elements of an augmented reality implementing system and relations between the elements according to an example embodiment of the present invention.

Referring to FIG. 1, an augmented reality implementing system according to an example embodiment of the present invention may include an augmented reality implementing device 10, a camera 20, an image outputting device (projector) 30, a virtual object database (DB) 40, and a motion pattern database 50.

In addition, referring to FIG. 1, the augmented reality implementing system according to an example embodiment of the present invention will be described below.

The augmented reality implementing device 10 is configured to enable interaction between the real world and a virtual world by generating a new image by adding a virtual object to a real image captured through the camera 20, and outputting the new image to the image outputting device 30.

For example, the augmented reality implementing device 10 may extract an object from an image captured by using a variety of sensing modules such as optical cameras and infrared (IR) cameras. For example, the augmented reality implementing device 10 may identify an object by using a marker or tag in order to determine a virtual object corresponding to a paper card. The augmented reality implementing device 10 may perform user's fingertip tracking and gesture recognition in order to recognize a user's motions (such as video clicking, writing, and gaming) with respect to virtual objects (digital contents) projected through the projector 30.

Herein, various methods, such as a marker-based method using general ink and special ink (infrared, ultraviolet), a markerless-based method using peculiar features of an object, and an RFID tag-based method, may be used to recognize the type of paper card that is a target object. In general, various techniques focusing on colors, features and shapes of a hand and an object may be used as an image processing technique for tracking and recognizing a user tool (for example, a realistic tool or a user's hand) for interaction with a virtual object. However, an example embodiment of the present invention provides a method for tracking a motion of a user tool by using an invisible infrared specific pattern instead of a separate marker or sensor.

The image outputting device 30 may use a projector with a projection function to output an image received from the augmented reality implementing device 10. Herein, the projector may concurrently project an infrared specific pattern onto a space where the image is output, so that a pattern of a motion of a realistic tool or a hand motion of a user can be effectively derived.

The camera 20 may include a visible-ray (RGB) camera and an infrared (IR) camera. The IR camera may detect and capture an infrared specific pattern (for example, an infrared frame of a specific pattern) projected from the projector 30.

For example, when an infrared specific pattern is projected onto a space where a hand motion of a user is present, the projected infrared specific pattern may be distorted due to an uneven surface. The IR camera may capture the distorted infrared specific pattern, and the distortion of the captured infrared specific pattern may be used by the augmented reality implementing device 10 to analyze the pattern of a hand motion of the user.

Referring to FIG. 1, the augmented reality implementing device 10 may include an image capturing unit 110, a virtual object extracting unit 120, a motion command extracting unit 130, an image processing unit 160, and an image outputting unit 170. The respective elements will be described below.

The image capturing unit 110 may be configured to capture an image of a specific space photographed through a photographing device such as the camera 20. Herein, the input image may be an image photographed by an RGB camera or infrared camera, as described above. Herein, the photographed image may be a photographed image of a specific space in the real world. In addition, the captured image may include an image of an infrared specific pattern projected from the projector 30.

The virtual object extracting unit 120 may be configured to derive an object in an image captured by the image capturing unit 110, and extract a virtual object corresponding to the derived object from the virtual object database 40 or a virtual object storage.

Herein, the object may be a real thing in the input image, and may be, for example, an object that represents the real world in order to implement augmented reality. If a board game is implemented in augmented reality, the object may be a paper card for the board game.

Various techniques may be used to identify the type of an object. According to implementation methods, the object may be a marker-based object, a markerless-based object, or an RFID tag-based object. If the derived object is a marker-based object, the virtual object extracting unit 120 may extract a marker from an image of the object as an object identifier, and extract a virtual object corresponding to a pattern of the extracted marker from the virtual object database 40.

Herein, the virtual object database 40 may be located inside or outside the augmented reality implementing device 10, and may be configured to store an image of a virtual object corresponding to a pattern of the marker.

The motion command extracting unit 130 may be configured to derive a motion of a user tool for interaction with a virtual object from an image input through the image capturing unit 110, extract a motion pattern of the user tool from the derived motion, and extract a motion command corresponding to the extracted motion pattern from the motion pattern database 50.

Herein, the motion of the user tool may be a hand motion of the user or a motion of a realistic tool (such as an infrared pen). If a motion image of the user tool is a hand motion image, a predetermined image processing algorithm may be used to extract a hand region and analyze a fingertip region, thereby extracting a hand motion pattern. Herein, a known image processing algorithm may be used to extract an accurate hand region and analyze the shape of a finger. In addition, a known pattern recognition technique may be used to compare an analyzed hand motion with a pattern stored in the motion pattern database 50.

For example, when an image including a virtual object is output to the projector 30 with a projection function, the projector 30 may be configured to concurrently project an infrared specific pattern onto a space where the virtual object is projected.

In this manner, when the infrared camera is used to input a fingertip motion and a specific pattern concurrently projected, the motion command extracting unit 130 may analyze an image of a hand motion input concurrently with a specific pattern, analyze the fingertip region, and extract a hand motion pattern.

In addition, the object may disappear or be reduced in size according to a motion command corresponding to the hand motion pattern. The motion command corresponding to the hand motion pattern may be predefined in the motion pattern database 50, or may indicate video playing, writing, or the like.

The image processing unit 150 may be configured to generate a new image by adding a virtual object image extracted by the virtual object extracting unit 120 to an input object image. In addition, the image processing unit 160 may generate a new image by reflecting a motion command corresponding to a pattern of a hand motion of the user extracted by the motion command extracting unit 130 on an image of a virtual object indicated by the hand motion.

The image outputting unit 170 may be configured to output an image generated by the image processing unit 160 to the image outputting device 30. Herein, a projector capable of projecting the output image may be used as the image outputting device 30.

In addition, the image outputting unit 170 may perform image correction and peripheral environment recognition in order to output an image suitable for an output environment of the projector. Since a color may appear differently according to the features of a projection space, the image outputting unit 170 may perform radiometric compensation with respect to values such as brightness and color of an object to be actually projected. The image outputting unit 170 may perform geometric warping with respect to a distortion that may occur when a projection surface is not planar.

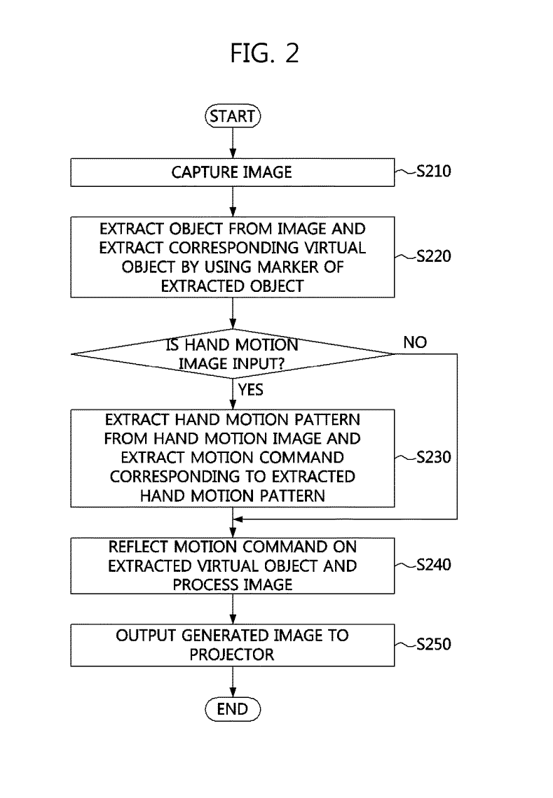

FIG. 2 is a flow diagram illustrating an augmented reality implementing process according to an example embodiment of the present invention.

Referring to FIG. 2, an augmented reality implementing process according to an example embodiment of the present invention may include an image capturing step S210, a virtual object extracting step S220, a motion command extracting step S230, an image processing step S240, and an image outputting step S250.

Referring to FIG. 2, the respective steps of the augmented reality implementing process according to an example embodiment of the present invention will be described below.

The image capturing step S210 may capture a real image photographed by a camera. Herein, the input image may be an image photographed by an RGB camera or infrared camera.

The virtual object extracting step S220 may derive an object in an image captured in the image capturing step S210, and extract a virtual object corresponding to the derived object from a virtual object storage or a virtual object database.

Various techniques may be used to identify an object. According to implementation methods, the object may be a marker-based object, a markerless-based object, or an RFID tag-based object. If the derived object is a marker-based object, an object identifier may be a marker.

For example, in the case of a marker-based object, a marker pattern may be extracted from the object and a virtual object corresponding to the extracted marker pattern may be extracted from the virtual object database. Herein, the virtual object database may be located inside or outside an augmented reality implementing device, and may be configured to store an image of a virtual object corresponding to a marker pattern.

The motion command extracting step S230 may derive a motion of a user tool from the image captured in the image capturing step S210, extract a pattern of the derived motion, and extract a motion command corresponding to the extracted motion pattern from the motion pattern database.

Herein, the motion of the user tool may be a hand motion of the user or a motion of a realistic tool (such as an infrared pen). For example, when a hand motion image is included in an image of the user tool, the motion command extracting step S230 may derive a motion of the user tool for interaction with a virtual object from the input image, extract a motion pattern of the user tool from the derived motion, and extract a motion command corresponding to the extracted motion pattern from the motion pattern database.

In addition, for example, when an image including a virtual object is output to a projector with a projection function, the projector may be configured to concurrently project an infrared specific pattern of an invisible region onto a space where the virtual object is projected.

In this manner, when an infrared camera is used to input a fingertip motion and a specific pattern concurrently projected, the motion command extracting step S230 may analyze an image of a hand motion input concurrently with a specific pattern, analyze a fingertip region, and extract a hand motion pattern.

The image processing step S240 may generate a new image by adding an extracted virtual object to an input object image. In addition, when a hand motion is detected from an input image and a motion command corresponding to a detected hand motion pattern is derived, the image processing step S240 may generate a new image by reflecting the derived motion command on an image of a virtual object indicated by the hand motion.

The image outputting step S250 may output an image generated in the image processing step S240 to an image outputting device, for example, a projector capable of projecting an output image.

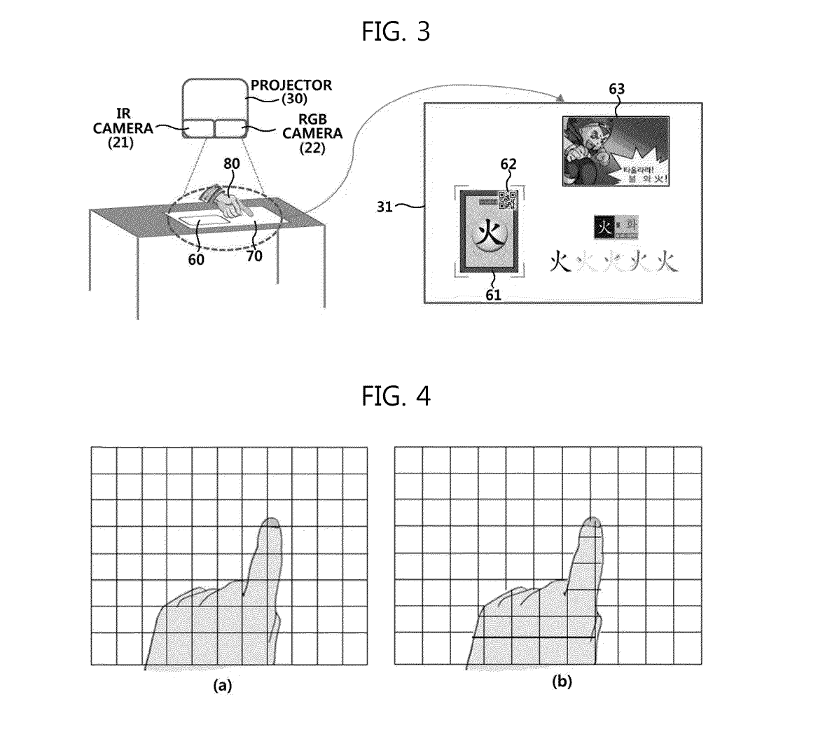

FIG. 3 is a conceptual diagram illustrating an example of providing a service by using an augmented reality implementing system according to an example embodiment of the present invention. FIG. 3 illustrates an example of a board game service.

A board game for Chinese character capability learning is illustrated in FIG. 3. In general, a board game for Chinese character capability learning includes a Chinese character workbook, Chinese character cards, and a game board. In the board game, the order is determined and the card is shifted block by block toward a magical thousand-character text fragment.

Referring to FIG. 3, in a board game using the augmented reality implementing system according to an example embodiment of the present invention, a card 60 and a game board 70 are placed on a table, and are photographed by an IR camera 21 and an RGB camera 22 installed at the projector 30. Photographed images are displayed on a screen 31 of the projector 30.

An image 61 of the card 60 and an image 63 of a virtual object corresponding to a marker 62 of the card 60 are displayed on the screen 31 of the projector 30. In addition, the user may make a hand motion toward the image 63 of the virtual object projected on the screen 31 of the projector 30, so that the virtual object may perform a new operation. As described above, the present invention proposes a method that can rapidly perform matching and output correction of the projector through the augmented reality implementing system equipped with the projector and the cameras, and can rapidly perform an interaction between an output image and the user with a reduced-operation. According to a process of the present invention, the following operations may be performed:

1. Synchronize the frames of the projector and the camera

2. Insert a frame of a specific pattern into an output of the synchronized projector

3. Capture an output image of a frame projected by the projector through the synchronized camera

4. Recognize a hand motion of the user, that is, an interaction through the captured image

A detailed description thereof will be given below with reference to the drawings.

FIG. 4 is a conceptual diagram illustrating a change corresponding to a hand motion of an infrared specific pattern projected by a projector of an augmented reality implementing system according to an example embodiment of the present invention.

Referring to FIG. 4, a grid type pattern frame is used to perform an interaction with a user's finger in an output image of a projector. FIG. 4A illustrates a pattern frame projected on a touch motion of the finger, and FIG. 4B illustrates a pattern frame when the finger is not touched thereto.

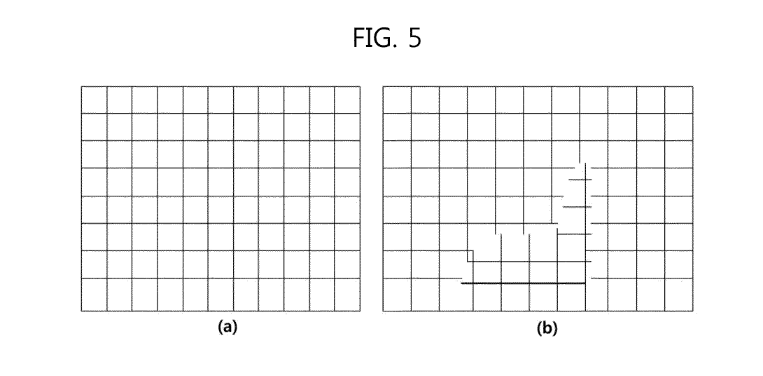

FIG. 5 is a conceptual diagram illustrating an image corresponding to the extraction of only an infrared specific pattern from an image projected by a projector of an augmented reality implementing system according to an example embodiment of the present invention.

As illustrated in FIG. 5, when only a pattern frame is extracted from a camera image and a pattern shape change is detected, a fingertip can be easily extracted. Based on this, hand motion (such as touch, drag, and release) can be recognized. In addition, image processing can be facilitated so that the amount of computation can be reduced.

When a hand or finger shape is recognized from a camera image, recognition rate changes severely according to skin color or peripheral environments in conventional methods. However, according to the present invention, the use of a pattern frame can reduce such recognition rate change and can achieve stable recognition results.

As described above, the augmented reality implementing system and method according to the present invention capture an image of an object, extract a virtual object corresponding to a marker or tag in the object from the virtual object database, derive a motion command corresponding to a pattern of a user's hand motion for interaction with the virtual object from the motion pattern database, and reflect the motion command on the virtual object, thereby making it possible to implement effective interaction with the user.

In addition, the augmented reality implementing system and method use the projector to project an infrared specific pattern, and use the infrared camera to capture a hand motion of the user in a space where the infrared specific pattern is projected. Accordingly, the augmented reality implementing system and method can recognize a hand motion pattern of the user more accurately and rapidly by using the infrared specific pattern.

While the example embodiments of the present invention and their advantages have been described in detail, it should be understood that various changes, substitutions and alterations may be made herein without departing from the scope of the invention.

What is claimed is:

1. A system for implementing augmented reality, comprising:
an image outputting device; and
an augmented reality implementing device configured to:
derive an object from a captured image of a specific space and extract a predetermined virtual object corresponding to the derived object;
when an image of a user tool for interaction with the virtual object is included in the captured image, reflect a motion command corresponding to a motion pattern of the user tool on the virtual object; and
generate a new image by reflecting the virtual object on the captured image, and output the new image to the image outputting device.

2. The system of claim 1, wherein the augmented reality implementing device comprises:
an image capturing unit configured to capture a photographed image of a specific space;
a virtual object extracting unit configured to derive an object from the captured image and extract a virtual object corresponding to the derived object from a virtual object storage;
a motion command extracting unit configured to, when an image of a user tool for interaction with the virtual object is included in the captured image, derive a motion pattern of the user tool and extract a motion command corresponding to the derived motion pattern from a motion pattern storage;
an image processing unit configured to add an image of the extracted virtual object to the captured image and reflect the extracted motion command on the virtual object to generate a new image; and
an image outputting unit configured to output the image generated by the image processing unit to the image outputting device.

3. The system of claim 2, wherein
the image outputting device inserts an infrared specific pattern into a received image prior to projection onto the specific space,
the system further comprises an infrared camera configured to photograph an infrared specific pattern projected onto the specific space,
the image capturing unit captures the infrared specific pattern photographed by the infrared camera, and
the motion command extracting unit derives a motion pattern of the user tool based on the captured infrared specific pattern.

4. The system of claim 3, wherein when the user tool is a hand, the motion command extracting unit extracts a hand region based on the infrared specific pattern and analyzes a fingertip region to extract the motion pattern.

5. The system of claim 3, wherein
the system further comprises a visible-ray camera configured to photograph an image of a user tool or an image of the object from the specific space, and
the image capturing unit combines images captured from the visible-ray camera and the infrared camera.

6. The system of claim 2, wherein the virtual object extracting unit detects a marker from an image of the derived object and extracts a virtual object corresponding to the detected marker from the virtual object storage.

7. A device for implementing augmented reality, comprising:
an image capturing unit configured to capture a photographed image of a specific space;
a virtual object extracting unit configured to derive an object from the captured image and extract a virtual object corresponding to the derived object from a virtual object storage;
a motion command extracting unit configured to, when an image of a user tool for interaction with the virtual object is included in the captured image, derive a motion pattern of the user tool and extract a motion command corresponding to the derived motion pattern from a motion pattern storage;
an image processing unit configured to add an image of the extracted virtual object to the captured image and reflect the extracted motion command on the virtual object to generate a new image; and
an image outputting unit configured to output the image generated by the image processing unit to an image outputting device.

8. The device of claim 7, wherein
the image outputting device projects an infrared specific pattern onto the specific space,
the image capturing unit captures the infrared specific pattern photographed by an infrared camera, and
the motion command extracting unit derives a motion pattern of the user tool based on the captured infrared specific pattern.

9. The device of claim 8, wherein when the user tool is a hand, the motion command extracting unit extracts a hand region based on the infrared specific pattern and analyzes a fingertip region to derive the motion pattern.

10. The device of claim 7, wherein when the object is a marker-based object, the virtual object extracting unit detects a marker from an image of the derived object and extracts a virtual object corresponding to the detected marker from the virtual object storage.

11. The device of claim 10, wherein the virtual object storage is located inside or outside the device, and an image of a virtual object corresponding to a marker is stored in the virtual object storage.

12. A method for implementing augmented reality in an augmented reality implementing device, comprising:
an image capturing step of capturing a photographed image of a specific space;
a virtual object extracting step of deriving an object from the captured image and extracting a virtual object corresponding to the derived object from a virtual object storage;
a motion command extracting step of, when an image of a user tool for interaction with the virtual object is included in the captured image, deriving a motion pattern of the user tool and extracting a motion command corresponding to the derived motion pattern from a motion pattern storage;
an image processing step of adding an image of the extracted virtual object to the captured image and reflecting the extracted motion command on the virtual object to generate a new image; and
an image outputting step of outputting the generated image to an image outputting device.

13. The method of claim 12, wherein
the image outputting device projects an infrared specific pattern onto the specific space,
the image capturing step captures the infrared specific pattern photographed by an infrared camera, and
the motion command extracting step derives a motion pattern of the user tool based on the captured infrared specific pattern.

14. The method of claim 13, wherein when the user tool is a hand, the motion command extracting step extracts a hand region based on the infrared specific pattern and analyzes a fingertip region to derive the motion pattern.

15. The method of claim 12, wherein when the object is a marker-based object, the virtual object extracting step detects a marker from an image of the derived object and extracts a virtual object corresponding to the detected marker from the virtual object storage.
